(19) United States
(12) Patent Application Publication
(10) Pub. No.: US 2016/0282821 A1
(43) Pub. Date: Sep. 29, 2016

(54) MANAGEMENT OF COMPLEX PHYSICAL SYSTEMS USING TIME SERIES SEGMENTATION TO DETERMINE BEHAVIOR SWITCHING

(71) Applicant: NEC Laboratories America, Inc., Princeton, NJ (US)

(72) Inventors: Haifeng Chen, Old Bridge, NJ (US); Tan Yan, Bedminster, NJ (US); Guofei Jiang, Princeton, NJ (US)

(21) Appl. No.: 15/079,820

(22) Filed: Mar. 24, 2016

Related U.S. Application Data
(60) Provisional application No. 62/137,923, filed on Mar. 25, 2015.

(51) Int. Cl. G05B 13/04; G06F 17/18

(52) U.S. Cl. CPC G05B 13/041; G06F 17/18

(57) ABSTRACT

Systems and methods for managing one or more physical systems, including determining system behavior switching based on time series data from one or more sensors in the system. Time series is divided into a plurality of segments, and each of the segments represents a system behavior. A fitness model is generated for each of the segments to determine whether to select each of the segments as invariants, and an ensemble of local relationship models are built for each of the time series for each invariant to identify local behavior switching points over time. The identified local behavior switching points of each invariant are aggregated by aligning the local switching points of all invariant segments, computing a density distribution of the aligned switching points, and extracting local maximas of the density distribution to determine the global switching points. System operations are controlled based on the determined system behavior switching.

### RELATED APPLICATION INFORMATION

This application claims priority to provisional application Ser. No. 62/137,923 filed on Mar. 25, 2015, incorporated herein by reference in its entirety.

### BACKGROUND

1. Technical Field

The present invention relates to the management of physical systems, and more particularly, to the autonomic management of complex physical systems using time series segmentation to determine behavior switching.

2. Description of the Related Art

With the decreasing hardware cost and increasing demand for autonomic management, most complex physical systems (e.g., nuclear power plants, manufacturing systems, etc.) are now equipped with a large network of sensors distributed across different parts of the system. The readings of sensors are generally continuously collected, and may be regarded as time series, which reflects the operational status of system. Effectively modeling and discovering patterns from the sensor data is important to improve system operations and many management tasks (e.g., anomaly detection, capacity planning, etc.).

One important observation from physical systems is that their operations usually switch between different states. For example, manufacture systems usually follow certain production workflows, which may automatically switch to a new process after completing the previous process. In many cases, system operators do not even know the exact time that system behavior switches. Determining behavior switching along time may essential include segmenting the collected time series into regions, each representing a system behavior. Conventional approaches are either based on dynamic programming or heuristics. Recently, due to the high demand of efficient and flexible mining and optimization systems and methods, optimization has been attempted to be employed to effectively analyze tune series. However, conventional optimization-based methods currently are only applicable to single time series, and as such, cannot be applied to efficiently discover complex system dynamics for management of complex physical systems.

### SUMMARY

A method for managing one or more physical systems, including determining system behavior switching based on time series data from one or more sensors in the system. Time series is divided into a plurality segments, and each of the segments represents a system behavior. A fitness model is generated for each of the plurality of segments to determine whether to select each of the plurality of segments as an invariant, and an ensemble of local relationship models are built for each of the time series for each invariant to identify local behavior switching points over time. The identified local behavior switching points of each invariant are aggregated by aligning the local switching points of all the invariant segments, computing a density distribution of the aligned local switching points, and extracting local maximas of the density distribution to determine one or more global switching points. System operations are controlled based on the determined system behavior switching.

A system for managing one or more physical systems, including a behavior switching determination engine for determining global system behavior switching based on time series data from one or more sensors in the physical systems. A pair selector is configured to divide the time series into a plurality of segments, and each of the segments represents a system behavior. A model generator is configured to generate a model fitness score for each of the plurality of segments to determine whether to select each of the plurality of segments as an invariant, and to build an ensemble of local relationship models for each of the time series for each invariant to identify local behavior switching points over time. A result fuser for aggregating the identified local behavior switching points of each invariant, the aggregating including aligning the local switching points of all the invariant segments, computing a density distribution of the aligned local switching points, and extracting local maximas of the density distribution to determine one or more global switching points. A controller is employed to control system operation based on the determined system behavior switching

A computer-readable storage medium including a computer-readable program, wherein the computer-readable program when executed on a computer causes the computer to perform the steps for determining system behavior switching based on time series data. Time series is divided into a plurality of segments, and each of the segments represents a system behavior. A fitness model is generated for each of the plurality of segments to determine whether to select each of the plurality of segments as an invariant, and an ensemble of local relationship models are built for each of the time series for each invariant to identify local behavior switching points over time. The identified local behavior switching points of each invariant are aggregated by aligning the local switching points of all the invariant segments, computing a density distribution of the aligned local switching points, and extracting local maximas of the density distribution to determine one or more global switching points. System operations are controlled based on the determined system behavior switching.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with one embodiment of the present principles;

FIG. 2 shows an exemplary high-level method for determining behavior switching for management of physical systems, in accordance with an embodiment of the present principles;

FIG. 3 shows an exemplary system and method for determining behavior switching for management of physical systems, in accordance with an embodiment of the present principles;

FIG. 4 shows an exemplary plate diagram illustratively depicting a method for invariant segmentation, in accordance with an embodiment of the present principles;

FIG. 5 is a block/flow diagram illustratively depicting an exemplary high level system for behavior switching determination and management of physical systems, in accordance with an embodiment of the present principles; and

FIG. 6 is a block/flow diagram illustratively depicting an exemplary system for behavior switching determination and management of physical systems, in accordance with an embodiment of the present principles.

### DETAILED DESCRIPTION OF PREFERRED EMBODIMENTS

In one embodiment, the present principles may be employed to manage complex physical systems based on determining and/or analyzing behavior switching in complex physical systems using, for example, an optimization-based segmentation method which efficiently mines the massive amount of time series data in physical systems (e.g., sensor data). Unlike conventional methods that segment time series based on their shapes, the present principles may be employed to segment an ensemble of models learned from time series. An operation state of a system can be modeled by the ensemble of relationships between different system time series attributes (e.g., invariant model with pairwise relationships) according to various embodiments.

In some embodiments, when the system's operation state switches, the relationships among its attributes may break, and thus the relationship model learned for the previous state may no longer hold, which may result in a significant parameter change of the model to response to the behavior change. The present principles may be employed to learn such relationship models for each of a plurality of different system behaviors, thus enabling identification of behavior switching points by inferring it from the parameter change of the learned models along time. In one embodiment, to build such models for each of a plurality of behaviors, system behaviors may be determined from relationships of one of more attributes according to the present principles .

In a particularly useful embodiment, accurate and automated identification/determination of operational behavior switching may be employed for management ( autonomic management) of one or more systems (e.g., complex physical systems). In one embodiment, sensor readings may be collected from one or systems, and may be treated as time series. The present principles may be employed to discover system behavior switching by inferring the relationship changes between massive time series. The underlying switching identification determination may be performed using an optimization method according to the present principles. The optimization may include, for example, learning a sequence of local relationship models that can best fit the time series data, and then analyzing changes of the local relationships to identify system behavior switching.

In one embodiment, optimization may be performed by employing a low-level sophisticated optimization method and a high-level optimization method design strategy according to the present principles to achieve the large-scale problem solving for use in management of complex physical systems. The present principles may be employed to determine the global system behavior change by, for example, effectively aggregating the learned local relationship change and identifying system-level behavior switching points with a high level of identification accuracy and low computational complexity, thereby reducing system processing requirements. Moreover, the present principles may be employed to automatically discover system behavior switching based on the time series data gathered from sensors according to various embodiments.

In one embodiment, the task of identifying behavior switching may be formulated as an optimization problem, which captures the local relationships from different system attributes time series, and then for each relationship we learn a sequence of models to describe how it changes along time. The present principles may be employed to analyze the change for very local relationship, aggregate them, and use the aggregated local changes to identify the global behavior switching for the whole system for use in system management according to various embodiments.

However, there are several challenges to achieve this goal. These may include, for example the following: (1) Local relationship building: Since the system behaviors may be unknown, it is difficult to select the right attributes to build local relationships; (2) Model complexity: Even if the correct attributes are selected, the relationship modeling generally requires more parameters than traditional time series, and thus leads to higher model complexity; (3) Efficient solver: By its nature, the number of established local relationships e pairwise) usually is several orders of magnitude greater than the number of time series, which may calls for an efficient optimization method (e.g., algorithm) to quickly and accurately identify the solution; and (4) Result aggregation: Assembling a large quantity (e.g., hundreds, thousands, millions, etc.) of local relationship models learned from different system components together to determine the whole system behavior switching to generate a final output.

In one embodiment, a segmentation method according to the present principles may be employed to address such challenges. Although in some embodiments, the method does not depend on any models to build local relationships, to determine a comprehensive description of relationships in systems (e.g., complex systems), an invariant model may be employed as an illustrative example, which may build pairwise relationships between different time series according to the present principles.

In one embodiment, given a set of time series collected from a system, without knowing the system behavior, a sampling-based mechanism may be employed to select the correct system attributes to build pairwise local relationships. For each selected invariant pair, one or more objective functions may be designed (e.g., generated) and employed to identify its local behavior switching along time. This may be applied to determine the accuracy, complexity, and behavior switching frequency to for real-world system operations according to the present principles. To optimize the objective function, an efficient method, customized for relationship modeling, may be employed, and may include a low-level sophisticated optimization algorithm, and a high-level optimization strategy design. In some embodiments, with respect to the optimization method, the framework of, for example, Alternating Direction Method of Multipliers (ADMM) may be utilized for large-scale problem solving capability.

In some embodiments, a novel primal-dual active set method may be employed to efficiently further optimize the internal steps of ADMM for high-level optimization according to the present principles. With respect to the high-level optimization, a hierarchical block-wise optimization method may be employed to further enhance the problem solving efficiency according to various embodiments. After determining local behavior switching for each invariant, to discover the global system behavior change, an aggregation method which accurately aligns the massive local change points may be employed to discover the system-level behavior switching points. More particularly, a nonparametric model may be employed to search for peak density locations of the switching points identified from all invariants, and since those positions may be supported by most local relationships, they may be regarded as the global behavior switching points according to the present principles.

The present principles may be employed to achieve high accuracy in identifying global behavior switch points for systems with a mixture of states, and the designed hierarchical optimization method further greatly boosts the solving efficiency and speed as compared to conventional systems and methods. In some embodiments, the present principles may be employed to, for example, efficiently discover system behavior switching by inferring it from the relationship of system attributes with ensemble of models; formulate the objective of behavior switching discovery as an optimization problem, with novel methods to efficiently solve it and further boost the solution efficiency with a hierarchical optimization strategy; and aggregate the results to determine global system behavior switching with consideration of noise, event lag, etc.) using a fusion mechanism.

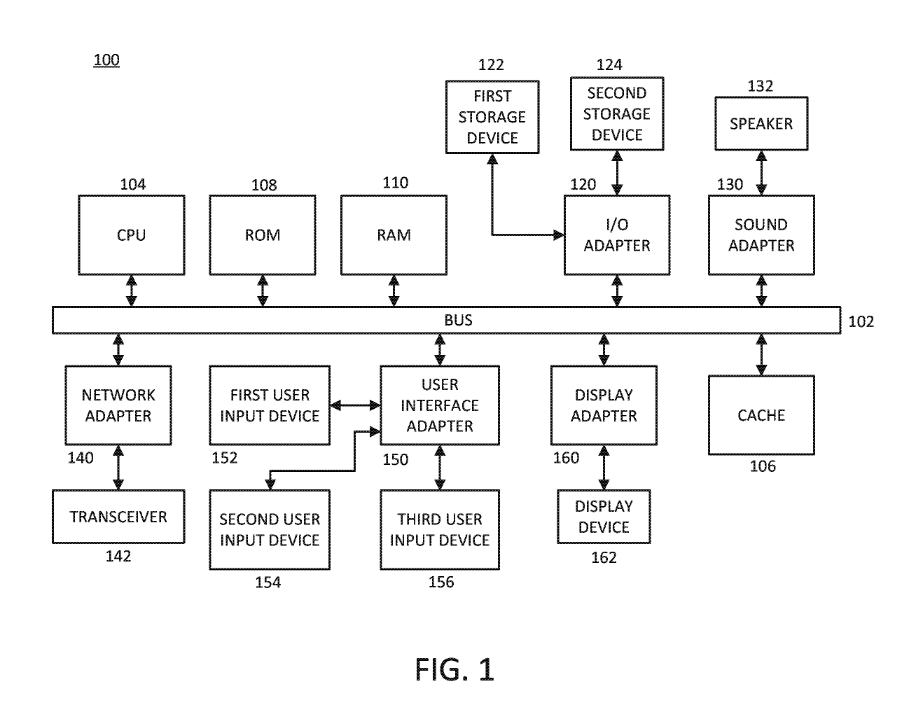

Referring now to the drawings in which like numerals represent the same or similar elements and initially to FIG. 1, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, various configurations can also be utilized as readily appreciated by one of ordinary skill in the art. These and other variations of the processing system 100 are readily contemplated by one of ordinary skill in the art given the teachings of the present principles provided herein.

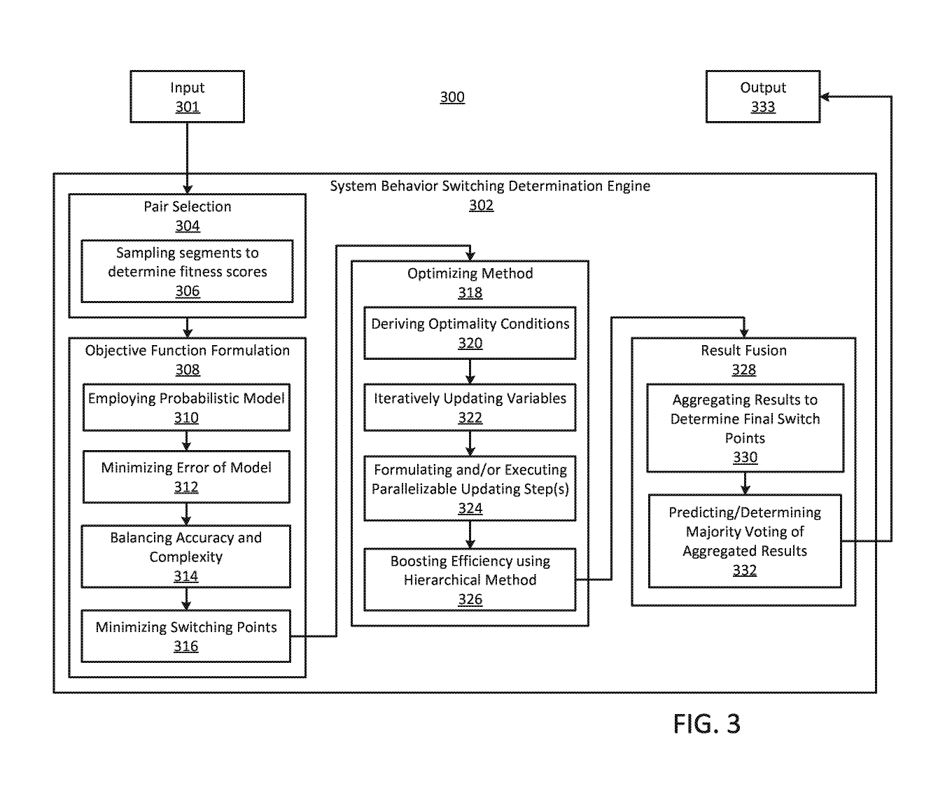

Moreover, it is to be appreciated that circuits/systems/networks 300, 500, and 600 described below with respect to FIGS. 3, 5, and 6 are circuits/systems/networks for implementing respective embodiments of the present principles. Part or all of processing system 100 may be implemented in one or more of the elements of systems 300, 500, and 600 with respect to FIGS. 3, 5, and 6.

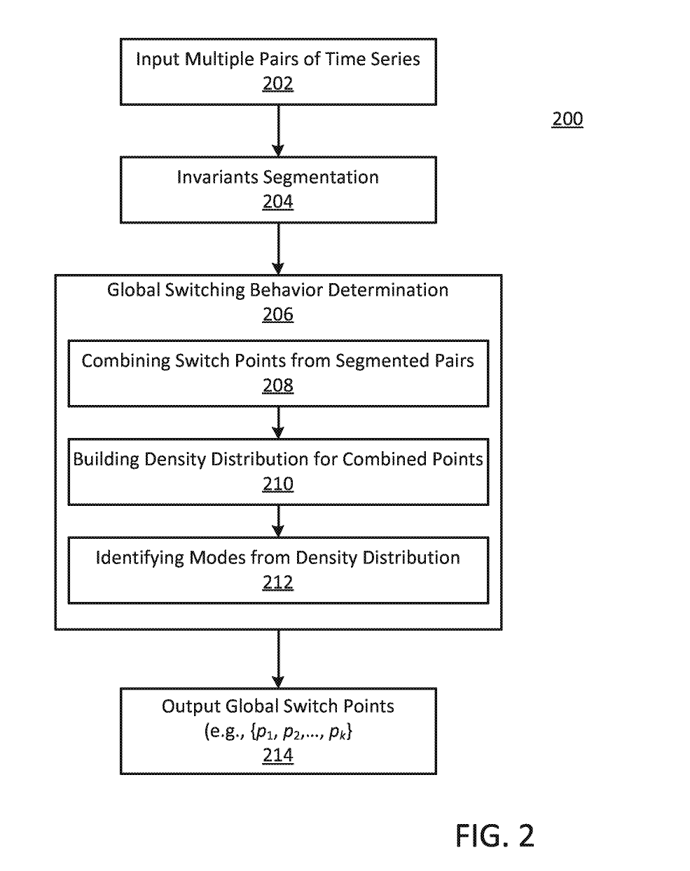

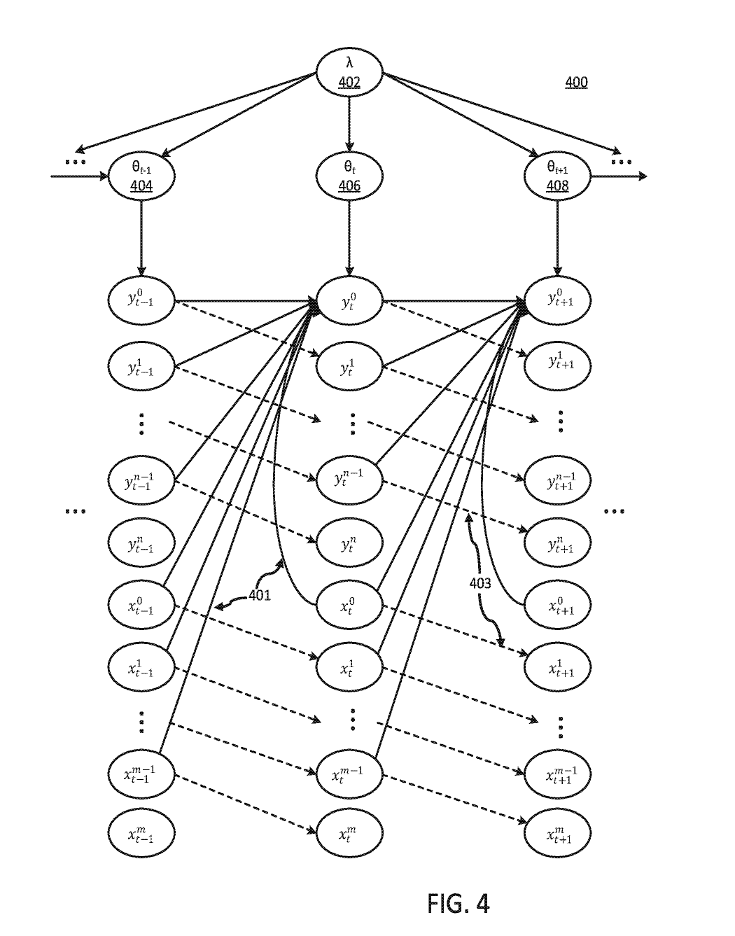

Further, it is to be appreciated that processing system 100 may perform at least part of the methods described herein including, for example, at least part of methods 200 and 400 of FIGS. 2 and 4. Similarly, part or all of circuits/systems/networks 300, 500, and 600 of FIGS. 3, 5, and 6 may be used to perform at least part of the methods described herein including, for example, at least part of methods 200 and 400 of FIGS. 2 and 4.

Referring now to FIG. 2, an exemplary high-level method 200 for determining behavior switching for management of physical systems is illustratively depicted in accordance with an embodiment of the present principles. Before describing the present principles in detail, some background regarding an invariant model employed according to the present principles is presented for ease of illustration. An invariant model may be employed to model an operational state of a system (e.g., complex system), and it is noted that herein the term “invariant” may represent a pair of time series where a local relationship model is built. It is noted that the described invariant model is shown as an exemplary model for illustrative purposes, and that the present principles may be applied using one or more of a plurality of types of models according to various embodiments.

In one embodiment, to determine one or more behaviors of a system, an invariant model may be generated, and may consider a pairwise relationship between two attributes x(t) and y(t) that employ an AutoRegressive relationship with eXogenous inputs (ARX):

y(t)+a₁y(t−1)+ . . . +aₙy(t−n)=b₀x(t)+ . . . +bₘx(t−m), (1)

where [n,m] is the order of the model that determines how many previous steps are affecting the current output. aᵢ and bⱼ are the coefficient parameters that reflect how strongly a previous step is affecting the current output. Denote:

θ=[a₁, . . . , aₙ, b₀, . . . , bₘ]^{T}, (2)

φ(t)=[−y(t−1), . . . , −y(t−n), x(t), . . . , x(t−m)]^{T}. (3)

Thus, Equation (1) may then be represented as follows:

y(t)=φ(t)^{T}θ (4)

The parameter θ in Equation (4) can be learned by minimizing the least squares error. After that, a score may be generated to evaluate how well the learned model ŷ(t) fits the measurement data according to the present principles, and only a pair with sufficiently high fitness score may be considered as an invariant.

In some embodiments, for systems with multiple states, for each invariant pair of a physical system (e.g., in a state), their relationship can be modeled with parameter θ. When the system state changes, their relationship in the previous state may no longer hold, which may result in a significant change of θ in the new model to fit the new state. The present principles may be employed to detect and/or analyze such change of θ for each of the invariants, and the aggregated change may be utilized for indicating/detecting the global behavior switching points of the entire physical system, which will be described in further detail herein below.

In one embodiment, one or more sets of time series (e.g., multiple pairs of e series) may be received as input in block 202. In block 204, pair selection and invariant segmentation may be performed according to the present principles. In block 204, multiple segments of the time series may be sampled, and a model fitness score may be generated for each segment (e.g., to determine whether to treat segments as invariant). A plurality (e.g., pre-determined threshold number) of random positions may be generated within the length of the time series. In one embodiment, for each of the time series pairs, a segment of the pairs may be selected, and a fitness score of the invariant model may be generated. In some embodiments, the segmentation in block 204 may be iteratively performed for all segments, and the highest determined score may represent a final score for the two time series. This invariant segmentation in block 204 may be performed for all pairs of time series, and those with high final scores (e.g., final score >0.7) may be selected as invariants. This final score 0.7 final score threshold) may be interpreted as a confidence score, and the confidence score may be represented by a number between zero and one according to one embodiment. The value one (1) indicates the model with the highest confidence, and the value zero (0) indicates the model with the lowest confidence.

In one embodiment, after selecting invariant pairs in block 204, a probabilistic model may be employed to capture switching points for each of a plurality of pairs for global switching behavior determination in block 206 according to the present principles. In block 206, a sequence of models may be built for each invariant in the system, which may extend an Autoregressive Exogenous (ARX) model to a piecewise invariant model to best fit its dynamic relationships along time. In one embodiment, relationship switch points may be identified for each invariant by analyzing the parameter change of the corresponding invariant

The present principles may be employed to build an ensemble of models which may be employed to monitor and/or manage real physical systems in block 206. In some embodiments, model accuracy, model complexity (e.g., which adds sparsity constraints to the model to reduce the member of parameters) and/or frequency of behavior switching (e.g., which may explicitly avoid the solution with too many switching points to reflect the realistic operation of a physical system) may be considered and or controlled during model building in block 206 according to the present principles.

In some embodiments, model parameters may be treated/analyzed as a stochastic sequence that reflects the evolution of the system states. A probabilistic model may be built on the sequence to characterize the underlying dynamics in block 206, and the sequence may be estimated by maximizing its posterior probability, which may include maximizing a likelihood function and a prior probability density function. In some embodiments, a piecewise invariant model may be represented as an optimization problem and analyzed according to the present principles, which will be described in further detail herein below.

In one embodiment, an Alternating Direction Method of Multipliers (ADMM) framework may be employed to solve a formulated optimization problem and to segment the time series to determine global switching behavior in block 206. In one embodiment, the present principles may employ an ADMM framework (e.g., an iterative framework which may be employed for solving large-scale distributed convex optimization problems), and an underlying segmentation problem may be reformulated as an optimization problem with linear equality constraints (e.g., involving two separate classes of variables which may be solved under the setting of ADMM). In one embodiment, optimality and/or termination conditions for the reformulated/adapted problem may be derived, the reformulated problem may be iteratively solved in block 206 to determine global switching behavior accordance with the conditions), and global switch points (e.g., for one or more complex physical systems) may be identified and output in block 214 for use in, for example, system management according to the present principles.

In one embodiment, the present principles may be employed to aggregate identified switch points of all invariants to identify global behavior switch points for an entire system in block 206. In block 208, the switch points of all the segmented pairs may be aligned/combined, and a scatter plot (e.g. representing distributions of switch points across a time range) may be generated according to the present principles.

In one embodiment, in block 210, a density distribution of the aggregated switch points may be built/computed using, for example, kernel density estimation, and data points may be regarded as sampled from a density distribution function, and may determine/identify such functions from the data points in accordance with the present principles. In block 212, one or more modes may be identified from the local maximas of the density distribution function using, for example, the Mean Shift algorithm. In some embodiments, such maxima points may be regarded as the global switching points (e.g., because they are supported by invariant models), and the determined global switch points may be output in block 214 in accordance with the present principles.

In some embodiments, to further improve the efficiency of the system, a two-phase hierarchical method may be employed in block 206 to solve the above-mentioned problems. For example, in one embodiment, Phase 1 of the hierarchical method may include dividing time indices into multiple blocks, and reducing the variable number for each block. Some of the blocks may be considered falsely allocated if they include the true switch point. If a block does not include any switch points, this may mean that it includes a single operation behavior, and may be referred to as “correctly allocated” herein. If a block does include a switch point, this may mean that it includes multiple operations behaviors, and may be referred to as “falsely allocated” herein. In Phase 2, switch points may be identified by building a point-wise model on each of any suspicious blocks in accordance with various embodiments of the present principles.

Referring now to FIG. 3, with further reference to FIG. 4, an exemplary system and method 300 for determining behavior switching for management of physical systems is illustratively depicted in accordance with an embodiment of the present principles. In one embodiment, data (e.g., time series) may be input in block 301 into a system behavior switching determination engine 302 to determine system behavior switching using, for example, segmentation and invariant modeling according to the present principles.

In one embodiment, pair selection may be performed (e.g., via sampling) for one or more systems (e.g., with multiple states) in block 304 according to the present principles. In general, given a system with multiple states, for two time series, it is likely that such time series may only be considered as invariant for certain states, and may not be correlated when considering all the states. To utilize an invariant model in such systems (e.g., with multiple states), invariants with unknown system behavior switching points may be selected in accordance with various embodiments of the present principles.

In some embodiments, multiple segments of the time series may be sampled, and a model fitness score may be computed for each segment in block 306 to determine whether to treat segments as invariant. For example, κ and M may be used to denote the sample frequency and sample size, respectively, and κ random positions {r₁, r₂, . . . , r_{κ}} may be generated within the length of the time series. In one embodiment, for each two time series, segments of the pairs {rᵢ, rᵢ₊₁, . . . , r_{i+M-1}} may be selected, and a fitness score of the invariant model may be generated/determined for each of the segments in block 306 using, for example, Equation (4) in accordance with the present principles. In some embodiments, the segmentation in may be iteratively performed for all of the κ segments, and the highest determined score may represent a final score for the two time series. This invariant segmentation may be performed for all pairs of time series in block 306, and those with high final scores (e.g., final score >0.7) may be selected in block 304 as invariants in accordance with the present principles.

In one embodiment, an objective function may be formulated and employed to capture switching points for each of one or more invariant pairs in block 308 according to the present principles. In block 310, a probabilistic model may be employed to represent relationship switching between each pair of two time series. In some embodiments, we may treat the model parameter {θₜ} as a stochastic sequence θ₁, . . . , θ_{N}, that reflects the evolution of the system states. The probabilistic model may be built based on the sequence to characterize the underlying dynamics, and the sequence {θₜt} may then be determined (e.g., estimated) by maximizing its posterior probability, which may include maximizing a likelihood function and a prior probability density function in accordance with the present principles. In some embodiments, a piecewise invariant model may be represented as an optimization problem in block 318 and/or analyzed in block 328 according to the present principles.

In one embodiment, a probabilistic model may be employed in block 310, and may be utilized to characterize complex dynamic systems in accordance with the present principles. For illustrative purposes, denote the two time series as x(t) and y(t), each including N data points, and define [symbol] ={x₁. . . , x_{N}, y₁, . . . , y_{N}} as the observed data set. Rather than assuming the model parameter θₜ to be a constant parameter, the present principles may advantageously treat θₜ as a stochastic process that evolves in a piecewise constant fashion in accordance with various embodiments. Such adaptation in block 310 may incorporate the system behavior switching in the model, as the switching events may be accurately reflected and determined based on the change of θₜ in accordance with the present principles.

In some embodiments, an objective function is formulated with one or more constraints, conditions, specific purposes, and/or requirements in block 308 in accordance with the present principles. In one embodiment, the objective function may be formulated in block 312 to minimize the error (e.g., least squares error) of each of one or more models. The objective function may further be formulated to balance accuracy and complexity of the models in block 314, and to accurately reflect, and consider real-world system operations to avoid solutions with a large number of switching points (e.g., minimize number of switching points) in block 316 in accordance with the present principles.

Referring now to FIG. 4, with continued reference to FIG. 3, an exemplary plate diagram 400 illustratively depicting a method for invariant segmentation is shown in accordance with an embodiment of the present principles. For convenience of illustration, with respect to the description of the method of FIG. 4, we temporarily redefine the notation of a variable where appending a subscript of time index t emphasizes its fixation on t. We define [symbol] ₜ={yₜ⁰, . . . , yₜⁿ, xₜ⁰, . . . , xₜ^{m}}, where yₜ⁰=y(t), xₜ⁰=x(t), and the remaining variables may be obtained from observations at t−1 by the following:

yₜ⁰=y(t), xₜ⁰=x(t),

where the parameters m and n are determined using the ARX model in Equation (1) according to the present principles.

In one embodiment, the plate diagram 400 shows a probabilistic relationship between [symbol] ₜ and θₜ, and for illustrative purposes, the diagram 400 may include representations of θₜ₋₁ 404, θₜ 406, θₜ₊₁ 408, etc. according to the present principles. The diagram 400 may include dashed lines 403 to represent deterministic transitions, and solid lines 401 to represent probabilistic transitions. Note that λ 402 may be a hyper-parameter imposed on, for example, θₜ 406 to control model complexity and/or define a condition distribution P(θₜ|λ) in accordance with the present principles.

In one embodiment, the diagram 400 shows a probability that a sequence θ₁, . . . , θ_{N} happens conditioned on an observed data set [symbol] (e.g., the posterior probability) may satisfy:

P(θ₁, . . . , θ_{N}| [symbol] )∝P( [symbol] |θ₁, . . . , θ_{N})P(θ₁, . . . , θ_{N}), (5)

where the first component on the right side of Equation (5) is the likelihood of a particular observation given the sequence, and the second part is the prior probability of the sequence, which may carry with prior knowledge on θ₁, . . . , θ_{N} (e.g., such as a piecewise constant constraint) according to the present principles. These two components will be described in further detail herein below.

In one embodiment, the likelihood function may be expressed as follows:

$$\begin{matrix}P ( 𝒟 \vert {θ}_{1} , … , {θ}_{T} = P ( {𝒟}_{1} , … , {𝒟}_{T} \vert {θ}_{1} , … , {θ}_{T} ) \\ = P ( {𝒟}_{1} \vert {θ}_{1} ) {\prod }_{t = 2}^{N} P ( {𝒟}_{t} \vert {θ}_{t} , {𝒟}_{t - 1} ) .\end{matrix} \qquad ( 6 )$$

According to Equation (4), given observations [symbol] ₜ₋₁, only yₜ⁰ is a random variable with distribution:

P( [symbol] ₁|θ₁)˜ [symbol] (α₁^{T} θ₁, σ²)

P( [symbol] ₜ|θₜ, [symbol] ₜ₋₁)=P(yₜ⁰|θₜ, [symbol] ₜ₋₁)˜ [symbol] (αₜ^{T} θₜ, σ²),

where αₜ=[−yₜ¹, . . . , −yₜⁿxₜ⁰, . . . , xₜ^{m}]^{T}, and essentially αₜ may be the same as the vector φ(t) in Equation (4), but is represented in a different manner according to one embodiment of the present principles. As a result, the likelihood may be represented as follows:

$$P ( 𝒟 \vert {θ}_{1} , … , {θ}_{T} ) = {( \frac{1}{2 π σ} )}^{T / 2} {\prod }_{t = 1}^{T} exp \{ - \frac{{( {y}_{t} - {α}_{t}^{T} {θ}_{t} )}^{2}}{{σ}^{2}} \} \qquad ( 7 )$$

In one embodiment, the diagram 400 shows a probability distribution of θₜ 406 at time t, and may depend solely on θₜ₋₁ 404 and a hyper parameter 402 which may influence: the model complexity via θₜ. An exception may occur when t=1, in which case θ₁ may only be dependent on λ. As a result, the prior probability may be expressed as follows:

$$\begin{matrix}P ( {θ}_{1} , … , {θ}_{N} ) = P ( {θ}_{1} \vert λ ) {\prod }_{t = 2}^{N} P ( {θ}_{t} \vert {θ}_{t - 1} , λ ) \\ = P ( {θ}_{1} \vert λ ) {\prod }_{t = 2}^{N} P ( {θ}_{t} \vert {θ}_{t - 1} ) P ( {θ}_{t} \vert λ ) .\end{matrix} \qquad ( 8 )$$

That is, the probability of θₜ at time t may depend on its previous values θₜ₋₁, as well as the probability P(θₜ|λ) given a predefined hyper parameter λ 402 according to the present principles. Moreover, the two probabilities may embed different expectations on θₜ according to various embodiments.

In some embodiments, the probability P(θₜ|λ) is related to model complexity, and we may employ λ≧0 to control model complexity by controlling the sparsity of θₜ to balance accuracy and complexity of the model in block 314 as follows:

P(θₜ|λ)=exp {−λ∥θₜ∥₁}.

In block 316, switching frequency may be controlled, and as previously described, since θₜ may be expected to be piecewise constant to reflect the state change in real system operation according to various embodiments, a probability density function P(θₜ|θₜ₋₁) may enforce similarities between consecutive θs. In one embodiment, exponential family distribution may y be employed to model such expectations as follows:

P(θₜ|θₜ₋₁)=exp {−∥θₜ−θₜ₋₁∥}.

Thus, the prior probability may be determined using Equation (8), and may reflect model complexity and switch frequency requirements, which may be represented as follows:

$$P ( {θ}_{1} , … , {θ}_{N} ) = {\prod }_{t = 2}^{N} exp \{ - λ {‖ {θ}_{t} ‖}_{1} \} {\prod }_{t = 2}^{N} exp \{ - ‖ {θ}_{t} - {θ}_{t - 1} ‖ \} . \qquad ( 9 )$$

In one embodiment, after formulating the aforementioned constraints/requirements in block 308, they may be assembled together to derive an optimization model for identifying invariant relationship switching in block 318 according to the present principles. In one embodiment, the objective attempts to maximize logarithm posterior probability θ₁, . . . , θ_{N} given the observation [symbol] , as defined in Equation (5). By applying Equations (7) and (9) to the logarithm of Equation (5) and ignoring the constant additive item, the result is:

$${max}_{{θ}_{1} , … , {θ}_{T} } - \frac{1}{{σ}^{2}} {\sum }_{t = 1}^{T} {( {y}_{t} - {α}_{t}^{T} {θ}_{t} )}^{2} - λ {\sum }_{t = 1}^{N} {‖ {θ}_{t} ‖}_{1} - {\sum }_{t = 2}^{N} ‖ {θ}_{t} - {θ}_{t - 1} ‖ .$$

Equivalently, in some embodiments, the optimization model may be expressed in the form of:

$$\begin{matrix}{min}_{{θ}_{1} , … {θ}_{T}} \frac{1}{2} {\sum }_{t = 1}^{N} {( {y}_{t} - {α}_{t}^{T} {θ}_{t} )}^{2} + {λ}_{1} {\sum }_{t = 1}^{N} {‖ {θ}_{t} ‖}_{1} + {\sum }_{t = 2}^{N} ‖ {θ}_{t} - {θ}_{t - 1} ‖ , & ( 10 ) \\ where {λ}_{1} = \frac{{σ}^{2}}{2} λ and {λ}_{1} = \frac{{σ}^{2}}{2} & \end{matrix}$$

may be the regularization parameters.

In some embodiments, although Equation (10) may be derived through the probabilistic model 400 of FIG. 4, it may include intuitive interpretations according to the present principles. The objective function formulated in block 308 may serve as a cohesive measure of the model accuracy, model complexity, and the frequency of model switches in blocks 312, 314, and 316. The first component

$$\frac{1}{2} {\sum }_{t = 1}^{N} {( {y}_{t} - {α}_{t}^{T} {θ}_{t} )}^{2}$$

may reflect the expectation of obtaining a model with high accuracy. The second component λ₁Σₜ₌₁^{N}∥θₜ∥1 may be employed to determine the model complexity by, for example, enforcing sparsity on the invariants parameter θₜ. The third term may represent the component that controls the frequency of model switches in accordance with the present principles. By penalizing the changes of θₜ, this component may determine how frequent the switches may occur in one or more systems, and larger values of λ₂ may encourage the presence of, and result in fewer switching points in the optimization results based on the objective function formulation in block 316 according to various embodiments.

In one embodiment, the solution of Equation (10) (e.g., the sequence \hat{θ}₁, . . . \hat{θ}_{N}) may be an estimation of the real dynamics of {θₜ}. ∥\hat{θ}ₜ−\hat{θ}_{t-31 1}∥ may measure a statistical significance of an event that θₜ changed at time t. By the definition of P(θₜ|θₜ₋₁), it may be determined that for ∥θᵢ−θᵢ₋₁∥≧∈, where ∈≧0, it may be concluded with a confidence of over 1−e^{-∈} that θₜ is different with θₜ₋₁ (e.g., t is a switch point) according to the present principles.

In one embodiment, the optimization method in block 318 may efficiently and scalably be employed to solve Equation (10) according to the present principles. For example, the optimization method 318 may be designed to follow the framework of Alternating Direction Method of Multipliers (ADDM), which is an iterative framework that has been applied for solving large-scale distributed convex optimization problems. For ease of illustration, an ADMM framework and its general formulation will initially be described herein below.

In one embodiment, Equation (10) may be reformulated into an optimization problem with linear equality constraints involving two separable classes of variables in block 318, such that it may be solved under the setting of ADMM according to the present principles. Optimality and/or termination conditions may be derived for the adapted problem in block 320, and the method may iteratively solve the problem in block 322 according to one embodiment. This solving may include efficiently computing, for example, one or more of a plurality of generic steps of each ADMM iteration, and translating the optimization solution into pair segmentation results in accordance with the present principles.

In one embodiment, the optimization method in block 318 may be performed using ADDM, which is a framework for designing and applying efficient optimization solutions for achieving large-scale optimization capability by iteratively solving a problem in a decentralized manner. A typical ADMM problem formulation may be represented as follows:

$${min}_{{x}_{1} , {x}_{2}} \{ f ( {x}_{1} ) + g ( {x}_{2} ) \text{:} {A}_{1} {x}_{1} = {A}_{2} {x}_{2} \} , \qquad ( 11 )$$

where f, g are convex functions, and A₁, A₂ are linear coefficient matrices. To solve such a problem, the ADMM may be employed in block 322 to iteratively update x₁ and x₂ in an alternating manner that steers (x₁, x₂) progressively closer to the optimality condition.

In sot embodiments, this iterative updating method may be formulated to be parallelizable in block 324 in accordance with the present principles.

In block 318, Equation (10) may be reformulated and adapted to the form of Equation (11) so that ADMM may be applied in accordance with the present principles. To fit Equation (1) into the ADMM framework, we may first denote:

A:=[α₁, . . . , α_{N}]^{T}∈ [symbol] ^{N×s}

θ:=[θ₁^{T}, . . . , θ_{N}^{T}]^{T}∈ [symbol] ^{Ns}

and may introduce an auxiliary variable β as:

β:=[θ₂^{T}, . . . , θ_{N}^{T}]^{T}−[θ₁^{T}, . . . , θ_{N-1}]^{T}∈ [symbol] ^{(N-1)s}. (12)

In one embodiment, β is a block first-order difference of θₜ with respect to time t, which represents the parameter change between invariant models and identifies the behavior switch points, and thus may be a desirable solution to be obtained according to the present principles. Moreover, such block-wise formation of β according to the present principles allows it be computed in a distributed way, which greatly improve the scalability of the algorithm.

In one embodiment, by replacing variables, the original Equation (10) may be re-written, and may be formulated compactly as follows:

$${min}_{θ , β} \frac{1}{2} {‖ y - A θ ‖}^{2} + {λ}_{1} {‖ θ ‖}_{1} + {λ}_{2} {‖ β ‖}_{2 , 1} \\ s . t . β = D θ , \qquad ( 13 )$$

where D ∈ [symbol] ^{(N-1)}^{_{s×s}} is a linear operator which may be defined according to Equation (12), and ∥β∥_{2,1} may be the sum of 2-norms. Thus, it is clear that Equation (13) may follow the form of Equation (11), and (β, θ) may represent the solution that is desired to be computed in block 318.

In one embodiment, having converted Equation (10) to Equation (13), it may now be solved according to the present principles. In block 320, an optimality condition of the formulated problem may be derived for solvers to achieve an optimal solution according to the present principles. Before presenting the implementation details of the solver in detail, the optimality condition (e.g., KKT condition) for Equation (13) derived in block 320 will be described in accordance with various embodiments of the present principles. The optimality condition may be a condition in which a solver achieves an optimal solution for a particular problem. For example, for (θ*, β*) to be optimal, there may exist a dual variable μ*∈ [symbol] ^{(N-1)s}, such that:

β*−Dθ*=0, (14a)

0∈A^{T}(Aθ*−y)−D^{T}82 *+∂(λ₁∥θ*∥)₁, (14b)

(14c). (14c)

By convention, condition (14a) may be referred to as a primal feasibility condition, and Conditions (14b) and (14c) may be referred to as a dual feasibility condition. In one embodiment, the optimality essentially considers the solution (θ*, β*, μ*) to be optimal if it is both primal and dual feasible according to the present principles. Thus, the Condition (14) may provide an explicit and verifiable characterization of optimality. The amount that a solution violates Condition (14) may serve naturally as a measure of its distance to optimality in accordance with the present principles.

Practically, in the numerical sense, the Condition (14) may not always be exactly reached in block 320, and thus the corresponding numerical method may be designed to terminate once the solution becomes sufficiently close to optimality. To do so, the termination condition, or “closeness” (e.g., the amount of violating Condition (14)) may be explicitly measured in accordance with the present principles. For example, it may be assumed d that (θ, β, μ) is an intermediate iterate of ADMM, according to the design of ADMM, and that all iterates hold for (14c) in block 322. Therefore, we only need to measure the amount that (θ, β, μ) violates Conditions (14b) and (14c). The amount of violation of Condition (14a) can be measured/determined by ∥β−Dθ∥, and Condition (14b) be measured by the norm of difference between β and its immediate previous iterate in block 322 according to various embodiments.

In one embodiment, to derive the optimization method (e.g., algorithm) in an ADMM framework for Equation (13) in block 318, ρ>0 may be denoted as an arbitrary number and the augmented language of Equation (13) may be represented as follows:

$$ℒ ( β , θ , μ ) := \frac{1}{2} {‖ y - A θ ‖}^{2} + {λ}_{1} {‖ θ ‖}_{1} + {λ}_{2} {‖ β ‖}_{2 , 1} + {μ}^{T} ( β - D θ ) + \frac{ρ}{2} {‖ β - D θ ‖}^{2} . \qquad ( 15 )$$

In one embodiment, the present principles may be employed to implement an ADMM method specialized for Equation (13), as described in Method 1 below. Similarly to conventional iterative methods, an initial solution is first estimated for (θ, β*, μ*) in block 320, and then it may be iteratively updated in block 322 until an above-mentioned termination condition is satisfied, and the updating may be performed in a parallelizable manner in block 324. The efficiency of the method may be further boosted using a hierarchical solving method in block 326 in accordance with the present principles.

In one embodiment, for illustrative purposes, let εₒₚₜ>0 be the optimality tolerance for the ADMM framework described in Method 1 as follows:

Method 1 The ADMM framework for problem (13)

Input: an initial (θ⁰, β⁰, μ⁰).
Output: (θ^{k+1}, β^{k+1}, μ^{k+1}) after k + 1 updates.
1: for k = 0, 1, 2, . . . do
2: Set θ^{k+1} ← argmin_{θ} [symbol] (θ, β^{k}, μ^{k}).
3: Set β^{k+1} ← argmin_{β} [symbol] (θ^{k+1}, β, μ^{k}).
4: Set μ^{k+1} ← μ^{k} + ρ(β^{k+1} − Dθ^{k+1}).
5: if ||β^{k+1} − Dθ^{k+1}|| < εₒₚₜ and ||β^{k+1} − β^{k}|| < εₒₚₜ then
6: return (θ^{k+1}, β^{k+1}, μ^{k+1})
7: end if
8: end for

Method 1 may include, for each iteration, three generic steps (e.g., Steps 2-4). Step 4 may be regarded as trivial, and as such, the method to efficiently implement Steps 2 and 3 according to the present principles will be described in detail herein below. With respect to updating θ in block 322, the iteration counter may be temporarily dropped, and we may denote

$$ℒ ( β , θ , μ ) := {λ}_{1} {‖ {β}_{i} ‖}_{1} + {λ}_{2} ‖ {β}_{i} ‖ + 〈 {μ}_{i} , {β}_{i} 〉 + \frac{ρ}{2} {‖ {( β - D θ )}_{i} ‖}^{2} .$$

The augmented language from Equation (15) may be expressed as follows:

$$ℒ ( β , θ , μ ) = \frac{1}{2} {‖ y - A θ ‖}^{2} - {μ}^{T} D θ + {\sum }_{i}^{𝓁} {ℒ}_{i} ( β , θ , μ ) .$$

This may be plugged into Step 2 of Method 1 to provide:

$$\begin{matrix}arg {min}_{θ} ℒ ( β , θ , μ ) = arg {min}_{θ} \frac{1}{2} {‖ y - A θ ‖}^{2} - {μ}^{T} D θ + \frac{ρ}{2} {‖ ( β - D θ ) ‖}^{2} + \\ {λ}_{1} {‖ θ ‖}_{1} \\ = arg {min}_{θ} \frac{1}{2} {θ}^{T} ( {A}^{T} A + ρ {D}^{T} D ) θ - \\ {θ}^{T} ( {A}^{T} y + {D}^{T} μ + ρ {D}^{T} β ) + {λ}_{1} {‖ θ ‖}_{1} .\end{matrix}$$

In some embodiments, the above may be a convex quadratic function with regularization. To solve this problem, the present principles may be employed to adopt a primal-dual active-set method. It is observed that after several initial ADMM iterations, the subsequent update of θ may usually be moderate (e.g., ∥θ^{k+1}−θ^{k}∥ is relatively small). By serving θ^{k} as the input of Step 2 in Method 1, the primal-dual active-set method according to the present principles is able to rapidly yield θ^{k+1}. Such an ability of utilizing an advantageous initial point is called “warm-start” and may be employed as an active-set method in accordance with the present principles.

In blocks 322 and/or 324, β may be updated in Step 3 of Method 1 in accordance with the present principles. In Step 3 of Method 1, separable, and thus may be minimized individually for each block [symbol] . Specifically by letting

$$z := D θ - \frac{μ}{ρ} ,$$

we immediately have:

$$\begin{matrix}arg {min}_{{β}_{i}} {ℒ}_{i} ( θ , {β}_{i} , μ ) = arg {min}_{{β}_{i}} {λ}_{2} ‖ {β}_{i} ‖ + 〈 {μ}_{i} , {β}_{i} 〉 + \frac{ρ}{2} {‖ {( β - D θ )}_{i} ‖}^{2} \\ = arg {min}_{{β}_{i}} {λ}_{2} ‖ {β}_{i} ‖ + \frac{ρ}{2} {‖ {( β - D θ + \frac{μ}{ρ} )}_{i} ‖}^{2} \\ = arg {min}_{{β}_{i}} {λ}_{2} ‖ {β}_{i} ‖ + \frac{ρ}{2} {‖ {β}_{i} - {z}_{i} ‖}^{2} .\end{matrix}$$

In some embodiments, this problem may be solved using a closed-form solution as follows:

$${β}_{i} = \{ \begin{matrix}0 , & if ρ ‖ {z}_{i} ‖ \leq {λ}_{2} \\ ( 1 - \frac{{λ}_{2}}{ρ ‖ {z}_{i} ‖} ) ρ {z}_{i} , & otherwise .\end{matrix}$$

In some embodiments, for large-scale problems using Method 1, updating β may be computationally intensive, and as such, a distributed implementation may be performed in block 324 according to the present principles to minimize such computational intensity. For example, according to the formulation of Equation (12), since each block βᵢ may be independent of other blocks, the updating of β can be carried out in a distributed fashion, which makes Method 1 efficiently applicable in large-scale settings. In block 326, the scalability of the solution may be further improved by employing a hierarchical optimization strategy in accordance with the present principles.

In one embodiment, the present principles may be employed to analyze and/or interpret results of the optimization in block 318. For example, the solution θₜ returned from Method 1 gives the invariant model at time t, whereas β includes the information regarding the change of θₜ, which may further indicates where the switch points are located. When the noise in the attributes is substantial, the identified switch points may enclose some false positives, and as such, in practice, the present principles may be employed to implement further refinement on the returned switch points using one or more denoising methods (e.g., mean shift) to eliminate such false positives in accordance with various embodiments.

In one embodiment, result fusion may be performed in block 328 to identify system global behavior switching using a system behavior switching determination engine 302 in accordance with the present principles. As previously described, the method 300 may be employed to identify the switch points and perform segmentation for each invariant pair of a system. In block 330, a method to aggregate the identified switch points of all the invariants to infer the global behavior switch points of the whole system is provided. This tray be performed in block 328 using, for example, the following method in accordance with the present principles.

In one embodiment, in block 328, the switch points of all the segmented pairs may be aligned/combined, and a scatter plot (e.g. representing distributions of switch points across a time range) may be generated. A density distribution of the aggregated switch points may be built/computed using, for example, kernel density estimation, and data points may be regarded as sampled from a density distribution function, and may determine/identify such functions from the data points in accordance with the present principles. One or more modes may be identified from the local maximas of the density distribution function using, for example, the Mean Shift algorithm, and such maxima points may be regarded as the global switching points (e.g., because they are supported by invariant models), and the determined global switch points may be output in block 333 in accordance with the present principles.

In block 330, during switch points aggregation, the segmented switch points of an invariant pair may indicate the behavior change between the two corresponding components. Individually, the information obtained from the segmentation result of a single pair may be obscure. However, by aggregating the switch points of all segmented pairs, the apparent pattern on the combined data points may result in an accurate and reliable inference on the system behavior switching. In some embodiments, by aligning the switch points of all the invariant pairs, and then determining the densest regions along a timeline, the switch points that are supported by most of the invariant pairs may be identified in block 330.

In one embodiment, kernel density estimation may be performed in block 332 according to the present principles. For example, to determine the densest regions, kernel density estimation may be employed to estimate the density of each aligned switch points along a time line in accordance with the present principles. In one embodiment, we may denote the set of combined data points of all segmented pairs as S (e.g., to extract the density of points in S), and regard S as sampled from a continuous empirical probability density function f. The density of each point in the time range may be computed using the (weighted) mean of the neighboring data points as the estimation, and may determine the densest regions in accordance with the present principles.

As an illustrative embodiment regarding kernel density estimation in block 332, assume that the data points in ct-dimensional space, and the function K(u): [symbol] ^{d}

[symbol]

may be called the kernel, which satisfies the following properties:

K(u)=K(−u)≧0

K(0)≧K(u) for u≠0

K(u)=0 for ∥u∥>1

∫ᵤK(u)du=1 (16)

Some exemplary kernel function examples include:

$$Flat$$

$$K ( u ) = \{ \begin{matrix}1 , & if ‖ u ‖ \leq 1 \\ 0 , & otherwise\end{matrix} \\ Epanechnikov \\ K ( u ) = \{ \begin{matrix}\frac{3}{4} ( 1 - {‖ u ‖}^{2} ) , & if ‖ u ‖ \leq 1 \\ 0 , & else\end{matrix}$$

The data points may be denoted as S={x₁, . . . , xₙ}, and given a kernel K and a bandwidth h, the recovered density function \hat{f} for S in block 332 may be represented as follows:

$$\hat{f} ( u ) = \frac{1}{{nh}^{d}} {\sum }_{i = 1}^{n} K ( \frac{u - {x}_{i}}{h} ) . \qquad ( 17 )$$

In one embodiment, in block 332, a mechanism to determine the maximas in f (e.g., densest regions in S) may include applying a mean shift method according to the present principles. The mean shift method may be applied to locate local maximas of the recovered density function \hat{f} in an iterative manner, which will be described in further detail with reference to Method 2 below:

Method 2 The Mean Shift algorithm for modes discovery

Input: Input the set of observed data S, bandwidth h.
Output: The set of local maximas [symbol] .

| | |
|---|---|
| 1: | for xᵢ ∈ S, initialize u = xᵢ do |
| 2: | while u does not converge do |
| 3: | $Set u ← \frac{{\sum }_{j = 1}^{n} K ( \frac{u - {x}_{j}}{h} ) {x}_{i}}{{\sum }_{j = 1}^{n} K ( \frac{u - {x}_{j}}{h} )}$ |
| 4: | end while |
| 5: | Add u to [symbol] and associate xᵢ with u. |
| 6: | end for |

In one embodiment, since mean shift may be an iterative method, it may be shown how the Mean Shift iteration progressively improves the solution according to the present principles until it reaches a local maxima. For example, from each point u^{j} in the domain of \hat{f}, applying one iteration of Method 2 may shift u^{j} to u^{j+1}. According to the definition of mean shift, such update may be given by:

$${u}^{j + 1} = \frac{{\sum }_{i = 1}^{n} K ( \frac{{u}^{j} - {x}_{i}}{h} ) {x}_{i}}{{\sum }_{i = 1}^{n} K ( \frac{{u}^{j} - {x}_{i}}{h} )} . \qquad ( 18 )$$

In some embodiments, to determine proof of convergence (e.g., that the sequence {\hat{f}(u^{j})} generated by Mean Shift is monotonically non-decreasing and converges), a brief proof may be given as follows. First, note that the even symmetry of K(u) enables its profile function k: [symbol] to be defined as:

K(u)=k(∥u∥²).

Thus, it may follow that:

$$\begin{matrix}\hat{f} ( {u}^{j + 1} ) - \hat{f} ( {u}^{j} ) = \frac{1}{{nh}^{d}} {\sum }_{i = 1}^{n} ( K ( {‖ \frac{{u}^{j + 1} - {x}_{i}}{h} ‖}^{2} ) - k ( {‖ \frac{{u}^{j} - {x}_{i}}{h} ‖}^{2} ) ) \\ = \frac{1}{{nh}^{d}} {\sum }_{i = 1}^{n} {k}^{′} ( {‖ \frac{{u}^{j} - {x}_{i}}{h} ‖}^{2} ) ( {‖ \frac{{u}^{j + 1} - {x}_{i}}{h} ‖}^{2} - {‖ \frac{{u}^{j} - {x}_{i}}{h} ‖}^{2} ) \\ = \frac{1}{{nh}^{d + 2}} {\sum }_{i = 1}^{n} {k}^{′} ( {‖ \frac{{u}^{j} - {x}_{i}}{h} ‖}^{2} ) ( {‖ {u}^{j + 1} - {u}^{j} ‖}^{2} ) \\ \geq 0.\end{matrix}$$

In some embodiments, the first inequality shown above may utilize the convexity of the profile k, and the second inequality may come from the fact that k′(x)≦0 (e.g., k is a monotonically decreasing function). Since the sequence {\hat{f}(u^{j})} may be monotone and bounded, {u^{j}} may converge. Therefore, after a sufficient number of iterations, the local maximas of the recovered density function \hat{f} may be determined in block 332, thus identifying the global switch points. In some embodiments, to determine a sufficient number of iterations is dependent on the density distribution of data. However, for most situations, tens of iterations is generally enough iterations to achieve convergence according to the present principles.

As described above, the present principles may employ an efficient and scalable optimization method (e.g., Method 1) to obtain the switch point of each invariant pair. In Method 1, the problem complexity may grow linearly with the length of the time series, which may present a challenge for solving huge-scale problems. To further improve the problem solving capability and handle very large-scale time series, the present principles may further be employed to design and implement a two-phase hierarchical optimization strategy to solve the optimization and/or segmentation problem in block 326 according to various embodiments.

In some embodiments, the solution β of Equation (13) may usually be very sparse. Physically, this means that the behavior switching may occur infrequently, which is common based on the nature of real physical systems during the long term operation. Ideally, if it is known in advance (e.g., predicted) that θₜ=θₜ₊₁=θₜ₊₂= . . . =θₜ₊ₖ, then we could simply use θₜ to replace such whole block of k+1 points in Equation (13), and thus undercut the problem size in accordance with the present principles. When the switching points are rare, such a variable reduction approach may be employed to drastically reduce the problem complexity.

In block 326, in light of the above observation on solution sparsity, a two-phase hierarchical method (e.g., algorithm) may be employed to solve the problem. Phase-I may divide the time indices into multiple blocks and reduce the variable number for each block, and some of the blocks may be falsely allocated if they contain the true switch points. In such situations, binding θₜ on those blocks may cause unpredictable optimization results, but in practice the results usually show suspiciously distinct solutions with its neighbors. Next, Phase-II may identify the switch points by building a point-wise model on each of the suspicious blocks in accordance with the present principles.

In further detail, with respect to Phase-I of the hierarchical method, for illustrative purposes, assume that the invariants of length N may be dividable into δ blocks, where each block has equal size b (e.g., N=δ·b). Since it is assumed that all the values within each block are the same, γᵢ ∈ [symbol] ^{s} may be used to represent the iₜₕ block, where s is the length of θₜ. Mathematically, this means θₜ=γᵢ for t=ib+1, . . . , ib+b, which is equivalent to imposing extra constraints on Equation (13). Let e_{b} be the b-dimensional all-one vector, and Iₛ ∈ [symbol] ^{s×s} be the s-dimensional identity matrix, so that the linear constraints between θ and γ may be compactly expressed as follows:

$$[ \begin{matrix}{θ}_{1} \\ {θ}_{2} \\ ⋮ \\ {θ}_{N}\end{matrix} ] = [ \begin{matrix}{e}_{b} & 0 & … & 0 \\ 0 & {e}_{b} & … & 0 \\ ⋮ & ⋮ & ⋱ & ⋮ \\ 0 & 0 & … & {e}_{b}\end{matrix} ] ⊗ {I}_{s} γ = [ \begin{matrix}{I}_{s} & 0 & … & 0 \\ ⋮ & ⋮ & & ⋮ \\ {I}_{s} & 0 & … & 0 \\ 0 & {I}_{s} & … & 0 \\ ⋮ & ⋮ & & ⋮ \\ 0 & {I}_{s} & … & 0 \\ & & ⋱ & \\ 0 & 0 & … & {I}_{s} \\ ⋮ & ⋮ & & ⋮ \\ 0 & 0 & … & {I}_{s}\end{matrix} ] [ \begin{matrix}{γ}_{1} \\ {γ}_{2} \\ ⋮ \\ {γ}_{δ}\end{matrix} ] , \qquad ( 19 )$$

where γ∈ [symbol] ^{δs} is the concatenation of γᵢ for i=1, . . . , δ. Let M represent the linear transformation between θ and γ of Equation (19) (e.g., θ=Mγ), and thus, it is verifiable that the reduced Equation (13) may be formulated as follows:

$${min}_{γ , β} \frac{1}{2} {‖ y - \overline{A} γ ‖}^{2} + {\overline{λ}}_{1} {‖ γ ‖}_{1} + {\overline{λ}}_{2} {‖ \overline{β} ‖}_{2 , 1} \\ s . t . \overline{β} = \overline{D} γ , \qquad ( 20 )$$

where Ā=AM, λ̅₁=λ̅₁s, λ̅₂=λ₂. Note that D, similarly to D of Equation (13), is the block first-order difference operator but with reduced dimension.

In some embodiments, Equation (20) may be in the form of Equation (13), hence the ADMM method according to the present principles may be applicable to solve Equation (20) using the system behavior switching determination engine 302. The output of this step may include suspicious blocks that will be further investigated for switch points in Phase-II.

In some embodiments, Phase-II of the hierarchical optimization strategy in block 326 may be a refinement of Phase-I. After identifying the suspicious blocks from Phase-I, it is natural to zoom into each identified block and pinpoint the switch points by the original point-wise Equation (13). In practice a point-wise model may be constructed on indices which belong to both the suspicious block and its two adjacent neighboring blocks in accordance with the present principles. For example, it the i block is identified as a switch block by the solution of Equation (20), a corresponding point-wise Equation (13) may be built on the tune interval t ∈{(i−1)b, . . . ib, . . . (i+2)b} in accordance with the present principles. After such refinement, the output of Phase-II is the switch points searched from the identified switch blocks and their neighbors, which may be provided for result fusion in block 328 according to various embodiments.

In some embodiments, to ensure an efficiency boost using the hierarchical method in block 326, some guidelines for usage of Equation (20) are described. For example, the designed hierarchical Equation (20) (e.g., model) may include (2δ−1)s variables, which is much fewer than the original Equation (13), which may include (2N−1)s variables, given δ<<N in accordance with the present principles. Furthermore, Phase-II may be solved in a distributed manner since the processes of building and solving piecewise models on suspicious block may be independent of one another. In some embodiments, in the description, the time indices may be divided into blocks of equal size, which may be adjusted (e.g., in real time) to, for example, set different block sizes by incorporating prior knowledge according to the present principles.

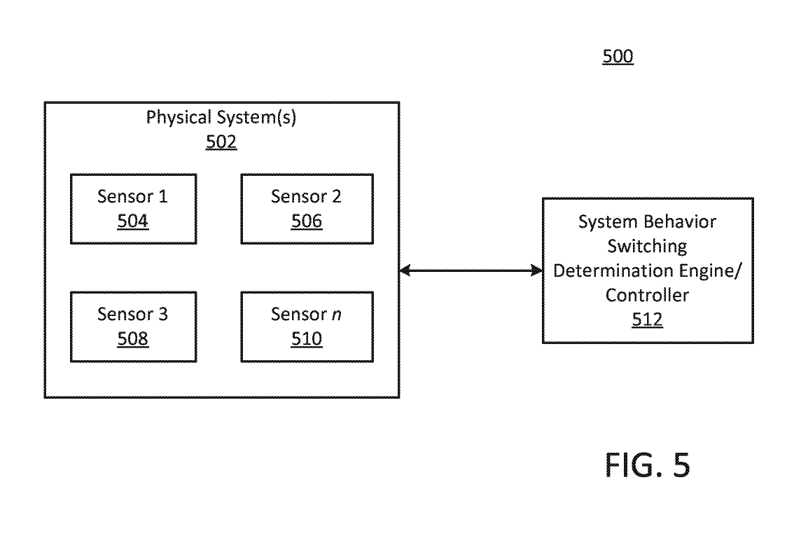

Referring now to FIG. 5, a high-level schematic 500 of an exemplary complex physical system including a system behavior switching determination engine/controller 512 is illustratively depicted in accordance with an embodiment of the present principles. In one embodiment, one or more complex physical systems 502 may be controlled and/or monitored using a switching determination engine/controller 512 according to the present principles. The physical systems may include a plurality of sensors 504, 506, 508, and 510 (e.g., sensors 1, 2, 3, . . . n), for detecting/measuring various system devices/processes.

In one embodiment, sensors 504, 506, 508, and 510 may include any sensors for any components now known or known in the future for monitoring and/or performing operations in physical (or virtual) systems (e.g., temperature sensors, pressure sensors, key performance indicator (KPI), pH sensors, etc.), and data collected from various sensors and/or components (or received (e.g., as time series)) may be employed as input to the switching determination engine/controller 512 according to the present principles. The switching determination engine/controller 512 may be directly connected to the physical system or may be employed to remotely monitor and/or control the quality and/or components of the system according to various embodiments of the present principles.

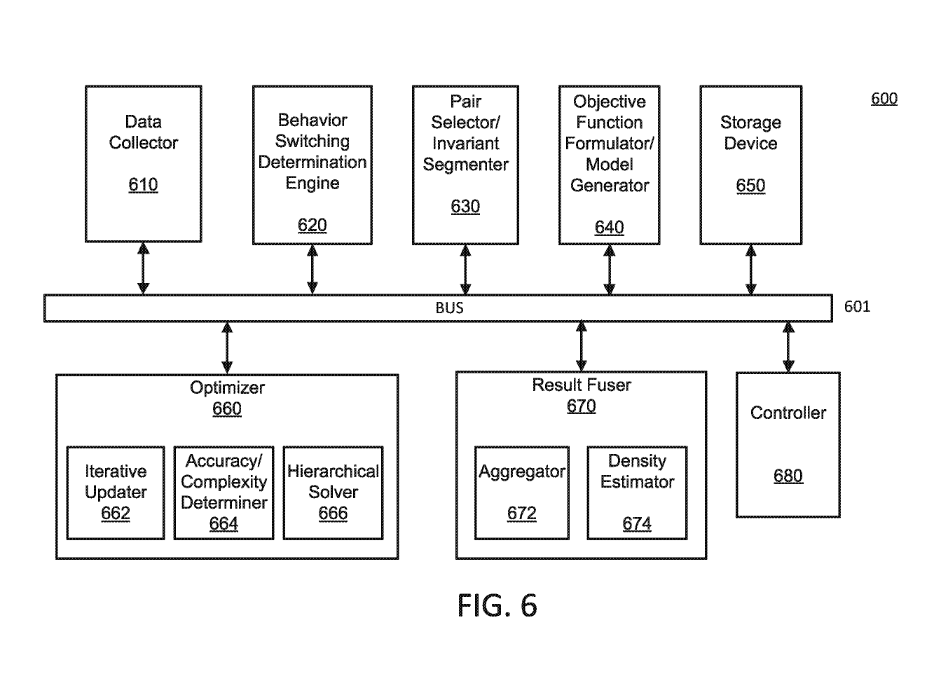

Referring now to FIG. 6, an exemplary system for behavior switching determination and management of physical systems 600 is illustratively depicted in accordance with an embodiment of the present principles.

While many aspects of system 600 are described in singular form for the sakes of illustration and clarity, the same can be applied to multiples ones of the items mentioned with respect to the description of system 600. For example, while a single controller 680 is illustratively depicted, more than one controller 680 may be used in accordance with the teachings of the present principles, while maintaining the spirit of the present principles. Moreover, it is appreciated that the controller 680 is but one aspect involved with system 600 than can be extended to plural form while maintaining the spirit of the present principles.

The system 600 may include a bus 601, a data collector 610, a system behavior switching determination engine 620, a pair selector/invariant segmenter 630, an objective function formulator 640, a storage device 650, an optimizer 660, which may further include an iterative updater 662, an accuracy/complexity determiner 664, and a hierarchical solver 666, a results fuser 670, which may further include an aggregator 672, and a density estimator 674, and/or a controller 680 according to various embodiments of the present principles.

In one embodiment, the data collector 610 may be employed to collect raw data (e.g., component aging data, time series, system operational status, etc.), and the raw data may be received as input to an aging profiler/time series transformer 620 (e.g., aging profiling engine). The system behavior switching determination engine 620 may be employed to determine system behavior switching using, for example, a pair selector/invariant segmenter 630, an objective function formulator 640, an optimizer 660, and/or a result fuser 670 in accordance with various embodiments of the present principles. A storage device 650 (e.g., non-transitory computer-readable storage medium) may be employed to store a plurality of data items/types (e.g., tune series, selected pairs, segments, etc.) for later access.

In some embodiments, the optimizer 660 may further include an iterative updater 662, an accuracy/complexity determiner 664, and/or a hierarchical solver, and the result fuser 670 may further include an aggregator 672 and a density estimator 674 according to the present principles. System operations may be controlled based on the determined behavior switching using a controller 680, and may include, for example, disabling and/or replacing components, accounting for anomaly detection, capacity planning and implementation, rerouting tasks, etc., according to various embodiments of the present principles.

The system and method according to the present principles may include an efficient method to discover system behavior switching (e.g., by inferring it from the relationship of system attributes with an ensemble of models). An objective problem for behavior switching discovery may be formulated as an optimization problem, and several novel methods according to the present principles may be applied in both low and high levels to efficiently solve the optimization problem. A further boost to the efficiency of the present system and method may be realized using a hierarchical optimization method according to the present principles. A fusion mechanism may be employed to aggregate the results from different system attributes to unveil the global system behavior switching (e.g., with the consideration of noise, event lag, etc.) with low computational complexity while achieving a high degree of accuracy in identifying behavior switching in one or more systems with a mixture of states in accordance with various embodiments of the present principles.

It should be understood that embodiments described herein may be entirely hardware or may include both hardware and software elements, which includes but is not limited to firmware, resident software, microcode, etc. In a preferred embodiment, the present invention is implemented in hardware.

Embodiments may include a computer program product accessible from a computer-usable or computer-readable medium providing program code for use by or in connection with a computer or any instruction execution system. A computer-usable or computer readable medium ay include any apparatus that stores, communicates, propagates, or transports the program for use by or n connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for managing one or more physical systems, comprising:
determining system behavior switching based on time series data from one or more sensors in the system, the determining further comprising:
dividing the time series into a plurality of segments, wherein each of the segments represents a system behavior;
generating a model fitness score for each of the plurality of segments to determine whether to select each of the plurality of segments as an invariant;
building an ensemble of local relationship models for each of the time series for each invariant to identify local behavior switching points over time;
aggregating the identified local behavior switching points of each invariant, the aggregating comprising:
aligning the local switching points of all the invariant segments;
computing a density distribution of the aligned local switching points; and
extracting local maximas of the density distribution to determine one or more global switching points; and
controlling system operation based on the determined system behavior switching.

2. The method as recited in claim 1, wherein an objective function is formulated for each of the invariants to identify the local behavior switching points over time.

3. The method as recited in claim 2, wherein optimization of the objective function is performed using an Alternating Direction Method of Multipliers (ADMM) framework.

4. The method as recited in claim 2, wherein at least one of optimality or termination conditions are derived for optimization of the objective function.

5. The method as recited in claim 1, wherein a probabilistic model is employed to determine relationship switching between the invariants.

6. The method as recited in claim 3, wherein the optimization comprises a two-phase hierarchical solving method.

7. The method as recited in claim 6, wherein the two-phase hierarchical solving method further comprises:
dividing time indices into multiple blocks to identify suspicious blocks and reduce a variable number for each of the multiple blocks; and
building a pointwise model for each of the suspicious blocks to determine the local behavior switching points.

8. The method as recited in claim 1, wherein the segments selected as the invariants include only segments with high final scores greater than 0.7.

9. A system for managing one or more physical systems, comprising:
a behavior switching determination engine for determining global system behavior switching based on time series data from one or more sensors in the physical systems, further comprising:
a pair selector configured to divide the time series into a plurality of segments, wherein each of the segments represents a system behavior;
a model generator configured to:
generate a model fitness score for each of the plurality of segments to determine whether to select each of the plurality of segments as an invariant; and
build an ensemble of local relationship models for each of the time series for each invariant to identify local behavior switching points over time;
a result fuser for aggregating the identified local behavior switching points of each invariant, the aggregating comprising:
aligning the local switching points of all the invariant segments;
computing a density distribution of the aligned local switching points; and
extracting local maximas of the density distribution to determine one or more global switching points; and
a controller for controlling system operation based on the determined system behavior switching.

10. The system as recited in claim 9, wherein an objective function is formulated for each of the invariants to identify the local behavior switching points over time.

11. The system as recited in claim 10, wherein optimization of the objective function is performed using an Alternating Direction Method of Multipliers (ADMM) framework.

12. The system as recited in claim 11, wherein at least one of optimality or termination conditions are derived for optimization of the objective function.

13. The system as recited in claim 9, wherein a probabilistic model is employed to determine relationship switching between the invariants.

14. The system as recited in claim 11, wherein the optimization employs a two-phase hierarchical solver.

15. The system as recited in claim 14, wherein the two-phase hierarchical solver is configured to:
divide time indices into multiple blocks to identify suspicious blocks and reduce a variable number for each of the multiple blocks; and
build a pointwise model for each of the suspicious blocks to determine the local behavior switching points.

16. The system as recited in claim 9, wherein the segments selected as the invariants include only segments with high final scores greater than 0.7.

17. A computer-readable storage medium including a computer-readable program for determining system behavior switching based on time series data from one or more sensors in the system, wherein the computer-readable program when executed on a computer causes the computer to perform the steps of:
dividing the time series into a plurality of segments, wherein each of the segments represents a system behavior;
generating a model fitness score for each of the plurality of segments to determine whether to select each of the plurality of segments as an invariant;
building an ensemble of local relationship models for each of the time series for each invariant to identify local behavior switching points over time;
aggregating the identified local behavior switching points of each invariant, the aggregating comprising:
aligning the local switching points of all the invariant segments;
computing a density distribution of the aligned local switching points; and
extracting local maximas of the density distribution to determine one or more global switching points; and
controlling system operation based on the determined system behavior switching.

18. The computer-readable storage medium as recited in claim 17, wherein an objective function is formulated for each of the invariants to identify the local behavior switching points over time.

19. The computer-readable storage medium as recited in claim 18, wherein optimization of the objective function is performed using an Alternating Direction Method of Multipliers (ADMM) framework.

20. The computer-readable storage medium as recited in claim 19, wherein the optimization comprises a two-phase hierarchical solving method, the two-phase hierarchical solving method further comprising:
dividing time indices into multiple blocks to identify suspicious blocks and reduce a variable number for each of the multiple blocks; and
building a pointwise model for each of the suspicious blocks to determine the local behavior switching points.
